(19) United States
(12) Patent Application Publication
(10) Pub. No.: US 2010/0070534 A1
(43) Pub. Date: Mar. 18, 2010

(54) GENERATION OF A BUSINESS ONTOLOGY FROM GLOBAL DATA TYPES

(76) Inventors: Jochen Gruber, Wiesloch (DE); Raluca Afloarei, Heidelberg (DE)

Correspondence Address: SAP AG, 3410 HILLVIEW AVENUE, PALO ALTO, CA, 94304, US

(21) Appl. No.: 12/211,232

(22) Filed: Sep. 16, 2008

(51) Int. Cl. G06F 17/30

(52) U.S. Cl. 707/797; 707/E17.055

(57) ABSTRACT

Described herein is a method for Global Data Type (GDT) ontology generation that involves parsing GDTs in order to define their basic components and building hierarchical structures for each GDT basic component. Each hierarchical structure is created by breaking down the corresponding GDT basic component into semantic elements and defining a relation between the elements, allowing easier navigation through the structure. New semantically compliant GDTs can be composed by combining already existing elements from the defined hierarchical structures. The GDT ontology eases GDT searching and simplifies the process of creating new GDTs.

### FIELD OF THE INVENTION

The field of invention relates generally to software, and particularly but not exclusively, relates to generation of hierarchical structures over a flat collection of data types.

### BACKGROUND OF THE INVENTION

A Global Data Type (GDT) represents a string comprising a concatenation of various elements having specific business semantics. The existing software products using GDTs usually have access to a plurality of already defined GDTs stored in a flat collection, and an option for the user to list the collection in order to find and use a specific GDT. Defining a new GDT involves a thorough analysis and approval of the new GDT proposal in order to verify semantic compliance with already existing GDTs, which makes GDT defining process time consuming and expensive.

A new GDT structure is required in order to guarantee effective searching and easy addition of new GDTs. A semantic structure of GDTs enriched with additional relations between the GDT elements would provide means for navigation, thus simplifying GDT searching. In such an ontology, new GDTs can be defined with respect to already existing GDT elements, thus accelerating the approval process.

### SUMMARY OF THE INVENTION

Described herein is a method for Global Data Type (GDT) ontology generation that involves parsing GDTs in order to define their basic components and building hierarchical structures for each GDT basic component. Each hierarchical structure is created by breaking down the corresponding GDT basic component into semantic elements and defining a relation between the elements, allowing easier navigation through the structure. New semantically compliant GDTs can be composed by combining already existing elements from the defined hierarchical structures. The GDT ontology eases GDT searching and simplifies the process of creating new GDTs.

### BRIEF DESCRIPTION OF THE DRAWINGS

A better understanding of the present invention can be obtained from the following detailed description in conjunction with the following drawings, in which:

FIG. 1 is an example of a Global Data Type (GDT) and its basic components, in accordance with an embodiment of the present invention.

FIG. 2 is a flow diagram of a process generating a hierarchical structure from the Object Classes of a flat collection of GDTs, in accordance with an embodiment of the present invention.

FIG. 3A is an example of a flat collection of GDTs in accordance with an embodiment of the present invention.

FIG. 3B is an example of a GDT business ontology generated from the flat collection shown on FIG. 3A, using the process described in reference to FIG. 2 below, in accordance with an embodiment of the present invention.

FIG. 3C is an example of defining new ontology elements using the already existing elements and adding them to the ontology, in accordance with an embodiment of the present invention.

FIG. 4 is a block diagram of a system for GDT ontology generation, in accordance with an embodiment of the present invention.

### DETAILED DESCRIPTION

Embodiments of a method and machine readable medium for Global Data Type (GDT) business ontology generation are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “this embodiment” means that a particular feature, structure, or characteristic described in connection with the embodiment is included in at least one embodiment of the present invention. Thus, the appearances of the phrases “in one embodiment” or “in this embodiment” in various places throughout this specification are not necessarily all referring to the same embodiment. Furthermore, the particular features, structures, or characteristics may be combined in any suitable manner in one or more embodiments.

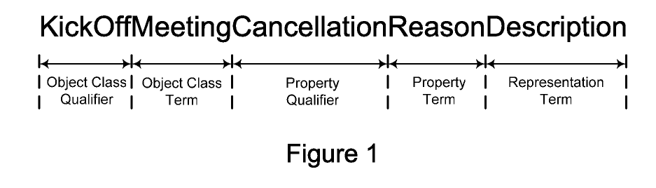

FIG. 1 is an example of a Global Data Type (GDT) and its basic components. In this embodiment, the GDT comprises three basic components: Object Class, Property, and Representation. The Object Class represents the main business semantic of the GDT. It is a set of ideas, abstractions, or things in the real world that can be identified with explicit boundaries and meaning and whose properties and behavior follow the same rules. Object Classes are the things about which we wish to collect and store data. Examples of Object Classes are cars, persons, households, employees, orders, etc. The Property is a characteristic feature shared by all the instances of an Object Class. Properties are used to distinguish or describe objects. Examples of Properties are color, model, sex, age, income, address, price, etc. Object Classes and Properties may need to be described using multiple words, depending on the natural language in use. In this case, they are further classified as qualifiers and terms. The terms represent a basic concept, while the qualifiers help to define and render the concept unique. The Representation describes how the data is represented, i.e. the data type and its value range. In this embodiment, the Representation is based on core data types, for example, Code, Name, Description, ID, etc.

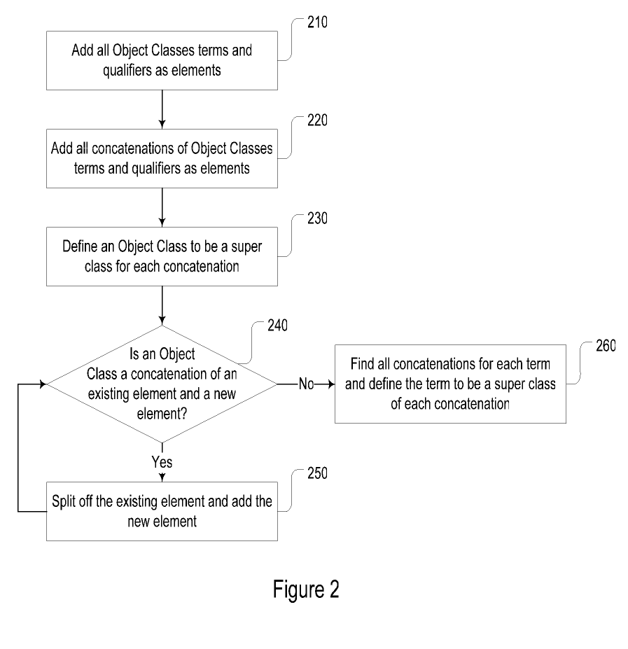

FIG. 2 is a flow diagram of a process generating a hierarchical structure from the Object Classes of a flat collection of GDTs. At block 210, all Object Classes terms and qualifiers are added as elements to the hierarchical structure. At block 220, all concatenations of each Object Class term and each qualifier are added as elements to the hierarchical structure. At block 230, Object Classes are defined as a super class for each one of their concatenations, thus defining a higher level of hierarchy. At block 240, a check is performed for each element of the hierarchical structure if it is a concatenation of already existing hierarchical structure element and a new element that is not present in the hierarchical structure. If there is such an element, the existing element is split off the new element at block 250 and the new element is added to the hierarchical structure. The check at block 240 is repeated until there are no more new elements to add. At block 260, for each element ‘X’ all elements ‘Y’ which are concatenations of the element ‘X’ and element ‘Z’ are located and the element ‘X’ is defined as a super class of all elements ‘Y’, thus defining new levels of hierarchy. The result is a hierarchy of elements by generalization of semantics.

Following the process described above, similar hierarchical structures are generated for the other GDT basic components. In this embodiment, the process produces Web Ontology Language (OWL) ontology, adhering to the OWL Lite World Wide Web Consortium (W3C) recommendation. The ontology represents a Resource Description Framework (RDF) graph which can be even more efficiently processed than the pure description logic that has become a cornerstone of the W3C Semantic Web for its use in the design of ontologies. OWL Lite also allows modeling of relations, their ranges, and domains to define the detailed relations between Objects Classes, Properties, and Representations. In addition, OWL Lite allows relations for integrating the GDTs into the ontology. In this extended business ontology, the GDTs are leafs whose semantics derives from the combined semantics of the related Object Class, Property, and Representation.

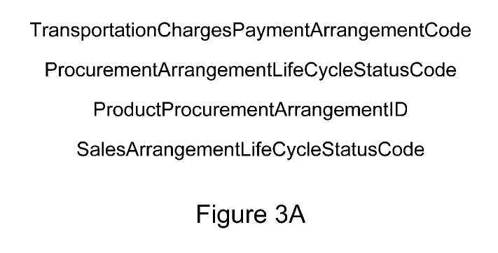

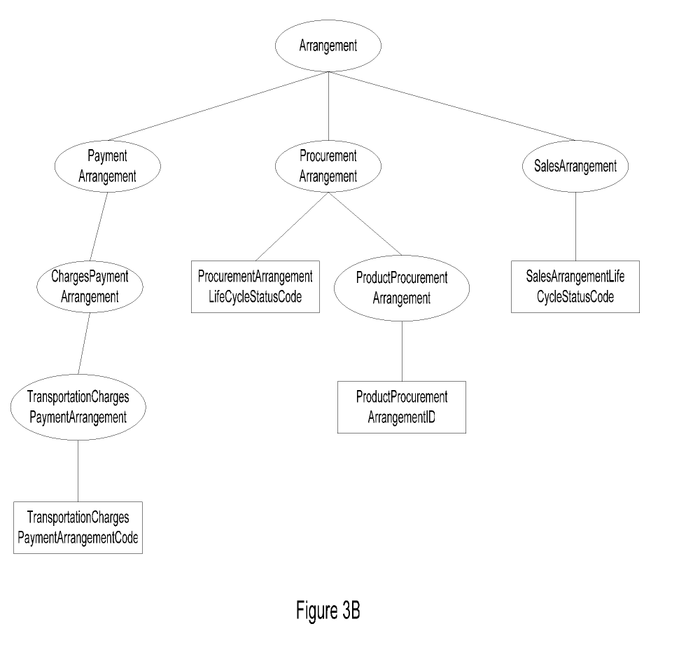

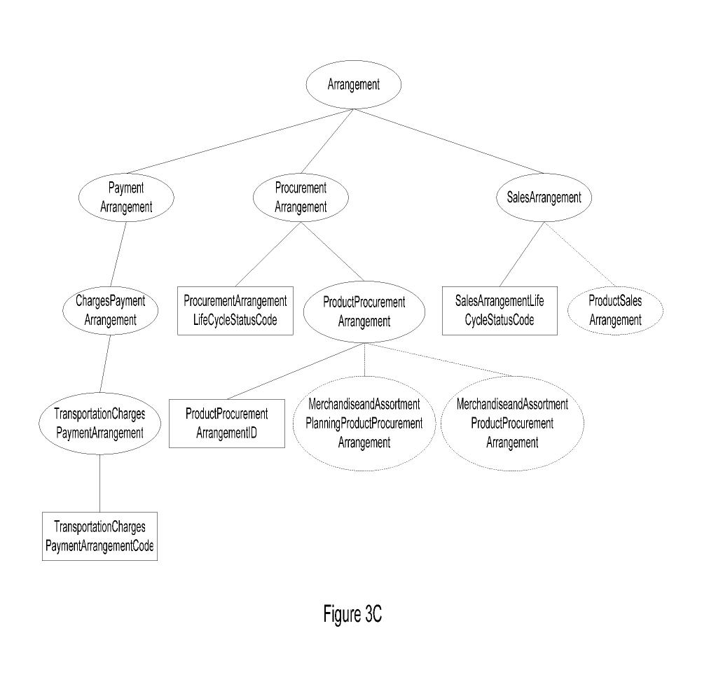

FIG. 3A is an example of a flat collection of GDTs. A result of applying the process described above on this flat collection is the GDT business ontology shown on FIG. 3B. The Object Classes of the GDTs from the flat list are: TransportationChargesPaymentArrangement, ProcurementArrangement, ProductProcurementArrangement, and SalesArrangement. At blocks 210 and 220 from FIG. 2 described above, these Object Classes will be added to the Object Class hierarchical structure along with the Object Class term Arrangement. At block 230, the element Arrangement will be defined as a super class of all elements and the element ProcurementArrangement will be defined as a super class for the element ProductProcurementArrangement. At blocks 240 and 250 from FIG. 2 described above, the following new elements will be split off the existing elements and added to the hierarchical structure: ChargesPaymentArrangement and PaymentArrangement. At block 260, ChargesPaymentArrangement will be defined as a super class of TransportationChargesPaymentArrangement, PaymentArrangement will be defined as a super class of ChargesPaymentArrangement and Arrangement will be defined as a super class of PaymentArrangement.

The ontology from FIG. 3B allows new elements to be defined with respect to already existing more general elements. FIG. 3C is an example of defining new ontology elements using the already existing elements and adding them to the ontology. The new Class Objects are: ProductSalesArrangement, which is defined as a subclass of the existing Object Class SalesArrangement, MerchandiseandAssortmentProductProcurementArrangement, and MerchandiseandAssortmentPlanningProductProcurementArrangement, defined as subclasses of ProductProcurementArrangement. Each newly added Object Class appears as a leaf in the hierarchical structure which guarantees semantic compliance with the already existing GDTs.

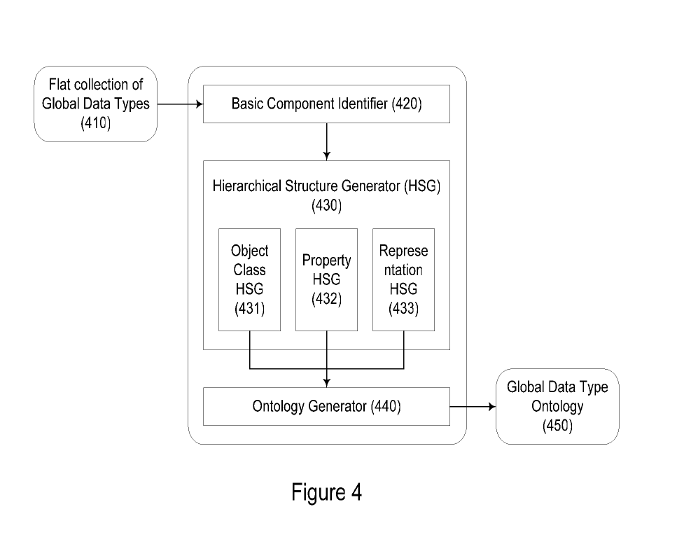

FIG. 4 is a block diagram of a system for GDT ontology generation. The Basic Component Identifier 420 parses the GDTs from the Flat Collection of GDTs 410 to identify GDT Object Class, Property, and Representation elements. Once basic components are identified, they are passed to the Hierarchical Structure Generator (HSG) 430. Within the HSG 430, the Object Class HSG 431 generates an Object Class hierarchical structure, the Property HSG 432 generates a Property hierarchical structure, and the Representation HSG 433 generates a Representation hierarchical structure. All hierarchical structures are generated following the process described in reference to FIG. 2 above. HSG 430 further separates each GDT basic component into a term and a qualifier. All terms, qualifiers, and their concatenations are added as elements to the respective hierarchical structure. HSGs 431, 432, and 433 further define relations between the elements and their concatenations to produce the RDF graph described in reference to FIG. 3B above. The Ontology Generator 440 generates GDT ontology from the hierarchical structures, generated by the HSG 430. In this ontology, the GDTs are leafs whose semantics derives from the combined semantics of the related Object Class, Property, and Representation.

The above description of illustrated embodiments of the invention, including what is described in the Abstract, is not intended to be exhaustive or to limit the invention to the precise forms disclosed. While specific embodiments of, and examples for the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A computerized method comprising:
identifying basic components of a plurality of Global Data Types;
generating a hierarchical structure for each basic component;
adding new elements in the hierarchical structures with respect to already existing elements; and
creating new Global Data Types by combining basic components from the hierarchical structures.

2. The method of claim 1, wherein identifying basic components comprises:
parsing the plurality of Global Data Types;
identifying an Object Class element;
identifying a Property element; and
identifying a Representation element.

3. The method of claim 2, wherein identifying an Object Class element comprises decomposing the Object Class element to an Object Class term and an Object Class qualifier.

4. The method of claim 3, wherein identifying a Property element comprises decomposing the Property element to a Property term and a Property qualifier.

5. The method of claim 4, wherein generating a hierarchical structure for each basic component comprises:
generating a hierarchical structure from the plurality of Object Class elements;
generating a hierarchical structure from the plurality of Property Elements; and
generating a hierarchical structure from the plurality of Representation elements.

6. The method of claim 5, wherein generating a hierarchical structure from the plurality of Object Class elements comprises:
adding to the hierarchical structure Object Classes terms and qualifiers;
adding to the hierarchical structure concatenations of Object Classes terms and qualifiers; and
defining different hierarchy levels by setting super class relations between the concatenations and the Object Classes terms.

7. The method of claim 5, wherein generating a hierarchical structure from the plurality of Property elements comprises:
adding to the hierarchical structure Properties terms and qualifiers;
adding to the hierarchical structure concatenations of Properties terms and qualifiers; and
defining different hierarchy levels by setting super class relations between the concatenations and the Property terms.

8. The method of claim 1, wherein adding new elements in the hierarchical structures with respect to already existing elements comprises:
adding new elements as leaves; and
defining the new elements as subclasses of the already existing elements.

9. The method of claim 1, wherein creating new Global Data Types by combining basic components from the hierarchical structures comprises:
selecting an Object Class element from the Object Classes hierarchical structure;
selecting a Property element from the Properties hierarchical structure;
selecting a Representation element from the Representation hierarchical structure; and
concatenating the selected basic components into a new Global Data Type.

10. A system for Global Data Types ontology generation comprising:
a basic component identifier to identify Global Data Type basic components;
a hierarchical structure generator to generate hierarchical structures for each Global Data Type basic component; and
an ontology generator to generate a Global Data Type ontology from the hierarchical structures of basic components.

11. The system of claim 10, wherein the Global Data Type component identifier parses a Global Data Type to identify an Object Class element, a Property element, and a Representation element.

12. The system of claim 11, wherein the hierarchical structure generator generates a hierarchical structure of Object Class elements, a hierarchical structure of Property elements, and a hierarchical structure of Representation elements.

13. A machine readable medium having a set of instructions stored therein which when executed cause a machine to perform a set of operations comprising:
identifying basic components of a plurality of Global Data Types;
generating a hierarchical structure for each basic component;
adding new elements in the hierarchical structures with respect to already existing elements; and
creating new Global Data Types by combining basic components from the hierarchical structures.

14. The machine readable medium of claim 13, having a set of instructions stored therein which when executed cause a machine to perform a set of operations, wherein identifying basic components comprises:
parsing the plurality of Global Data Types;
identifying an Object Class element;
identifying a Property element; and
identifying a Representation element.

15. The machine readable medium of claim 14, having a set of instructions stored therein which when executed cause a machine to perform a set of operations, wherein identifying an Object Class element comprises decomposing the Object Class element to an Object Class term and an Object Class qualifier.

16. The machine readable medium of claim 15, having a set of instructions stored therein which when executed cause a machine to perform a set of operations, wherein identifying a Property element comprises decomposing the Property element to a Property term and a Property qualifier.

17. The machine readable medium of claim 16, having a set of instructions stored therein which when executed cause a machine to perform a set of operations, wherein generating a hierarchical structure for each basic component comprises:
generating a hierarchical structure from the plurality of Object Class elements;
generating a hierarchical structure from the plurality of Property Elements; and
generating a hierarchical structure from the plurality of Representation elements.

18. The machine readable medium of claim 17, having a set of instructions stored therein which when executed cause a machine to perform a set of operations, wherein generating a hierarchical structure from the plurality of Object Class elements comprises:
adding to the hierarchical structure Object Classes terms and qualifiers;
adding to the hierarchical structure concatenations of Object Classes terms and qualifiers; and
defining different hierarchy levels by setting super class relations between the concatenations and the Object Classes terms.

19. The machine readable medium of claim 17, having a set of instructions stored therein which when executed cause a machine to perform a set of operations, wherein generating a hierarchical structure from the plurality of Property elements comprises:
adding to the hierarchical structure Properties terms and qualifiers;
adding to the hierarchical structure concatenations of Properties terms and qualifiers; and
defining different hierarchy levels by setting super class relations between the concatenations and the Property terms.

20. The machine readable medium of claim 13, having a set of instructions stored therein which when executed cause a machine to perform a set of operations, wherein adding new elements in the hierarchical structures with respect to already existing elements comprises:
adding new elements as leaves; and
defining the new elements as subclasses of the already existing elements.

21. The machine readable medium of claim 13, having a set of instructions stored therein which when executed cause a machine to perform a set of operations, wherein creating new Global Data Types by combining basic components from the hierarchical structures comprises:
selecting an Object Class element from the Object Classes hierarchical structure;
selecting a Property element from the Properties hierarchical structure;
selecting a Representation element from the Representation hierarchical structure; and
concatenating the selected basic components into a new Global Data Type.
